(19) United States
(12) Patent Application Publication
(10) Pub. No.: US 2024/0116493 A1
(43) Pub. Date: Apr. 11, 2024

(54) WHEELED GROUND VEHICLE ROLLOVER PROTECTION CONTROL BY TRAJECTORY LINEARIZATION CONTROL

(71) Applicant: Ohio University, Athens, OH (US)

(72) Inventors: Jianchao Zhu, Athens, OH (US); Yuanyan Chen, Logan, OH (US)

(21) Appl. No.: 18/479,916

(22) Filed: Oct. 3, 2023

Related U.S. Application Data
(60) Provisional application No. 63/378,123, filed on Oct. 3, 2022.
(60) Provisional application No. 63/487,693, filed on Mar. 1, 2023.

(51) Int. Cl. B60W 30/04

(52) U.S. Cl. CPC B60W 30/04; B60W 2520/14; B60W 2710/207; B60W 2720/18

(57) ABSTRACT

A rollover prevention and mitigation controller for a vehicle comprising a controller adapted to reduce or reverse lateral force via reduction of the velocity of a vehicle, and manipulation of a steering angle, wherein manipulation of the steering angle reduces or reverses the yaw rate.

### RELATED APPLICATION

This application claims the benefit of the filing date of U.S. Patent Application Ser. No. 63/378,123, filed Oct. 3, 2022, the disclosure of which is incorporated by reference herein in its entirety. This application also claims the benefit of the filing date of U.S. Patent Application Ser. No. 63/487,693, filed Mar. 1, 2023, the disclosure of which is incorporated by reference herein in its entirety.

### TECHNICAL FIELD

This application relates generally to devices, systems, and methods for preventing a wheeled ground vehicle such as a car or a truck from rollover accidents.

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Vehicle rollover accidents are extremely hazardous and have been identified as the most fatal type of single-vehicle crashes. In 2021, they accounted for 17.8% of all automobile accident fatalities [N. H. T. S. Administration et al., “Early estimates of motor vehicle traffic fatalities and fatality rate by sub-categories in 2021,” 2021]. The risk of rollover grows with the dimension and weight of the vehicle, such that sports utility vehicles (SUVs) and heavy trucks have a propensity to rollover due to their high center of gravity. Therefore, many rollover warning systems have been proposed as a component of Advanced Driver Assistance Systems (ADAS) in commercial vehicles. The rollover warning system typically uses a Rollover Index (RI) to detect or predict the rollover propensity. An active roll prevention system, if the vehicle is so equipped, will be activated after a prescribed threshold of rollover propensity is reached.

The National Highway Traffic Safety Administration (NHTSA) categorizes ground vehicle rollovers as either tripped or un-tripped. Tripped rollovers occur when a vehicle is subjected to external forces, such as colliding with a curb or another vehicle, which cause the vehicle to rollover. On the other hand, untripped rollovers occur as a result of a combination of factors including steering input, speed, and the friction between the tires and the ground. Regardless of the type, rollover is ultimately caused by excessive roll moment generated by lateral acceleration through the center of gravity (CG) of the vehicle.

Therefore, methods for preventing vehicle rollover can be broadly categorized into two categories: direct and indirect methods. Direct methods are those that produce a direct roll moment aimed at counteracting the likelihood of rollover. Regarding direct methods, active suspension [S. Yim, “Design of a preview controller for vehicle rollover prevention,” IEEE Transactions on Vehicular Technology, vol. 60, no. 9, pp. 4217-4226, 2011] and active anti-roll bar (AARB) have been implemented as part of the suspension system to reduce roll rate and enhance ride comfort [R. Lin, D. Cebon, and D. Cole, “Active roll control of articulated vehicles,” Vehicle System Dynamics, vol. 26, no. 1, pp. 17-43, 1996; S. Yim and K. Yi, “Design of an active roll control system for hybrid four-wheel-drive vehicles,” Proceedings of the Institution of Mechanical Engineers, Part D: Journal of automobile engineering, vol. 227, no. 2, pp. 151-163, 2013; D. Cimba, J. Wagner, and A. Baviskar, “Investigation of active torsion bar actuator configurations to reduce vehicle body roll,” Vehicle System Dynamics, vol. 44, no. 9, pp. 719-736, 2006; S. Yim and K. Yi, “Design of an active roll control system for hybrid four-wheel-drive vehicles,” Proceedings of the Institution of Mechanical Engineers, Part D: Journal of automobile engineering, vol. 227, no. 2, pp. 151-163, 2013]. Advanced actuators, such as four-wheel steering, four in-wheel motors [F. Wang and Y. Chen, “Hierarchical input-output decoupling control for vehicle rollover mitigation,” in Dynamic Systems and Control Conference, vol. 51890, p. V001T09A005, American Society of Mechanical Engineers, 2018] gyroscopic devices [B. Mashadi, M. Mokhtari-Alehashem, and H. Mostaghimi, “Active vehicle rollover control using a gyroscopic device,” Proceedings of the Institution of Mechanical Engineers, Part D: Journal of Automobile Engineering, vol. 230, no. 14, pp. 1958-1971, 2016], and active rollover preventers [F. Wang and Y. Chen, “A novel active rollover prevention for ground vehicles based on continuous roll motion detection,” Journal of Dynamic Systems, Measurement, and Control, vol. 141, no. 1, 2019], have also been employed to generate a counter roll moment directly for the purpose of preventing rollover.

Indirect methods, on the other hand, are designed to decrease the lateral forces exerted on the vehicle. These techniques aim to reduce lateral acceleration by either decreasing the yaw rate or longitudinal speed to prevent rollover [S. Yim, “Design of a preview controller for vehicle rollover prevention,” IEEE Transactions on Vehicular Technology, vol. 60, no. 9, pp. 4217-4226, 2011; R. Lin, D. Cebon, and D. Cole, “Active roll control of articulated vehicles,” Vehicle System Dynamics, vol. 26, no. 1, pp. 17-43, 1996; S. Yim and K. Yi, “Design of an active roll control system for hybrid four-wheel-drive vehicles,” Proceedings of the Institution of Mechanical Engineers, Part D: Journal of automobile engineering, vol. 227, no. 2, pp. 151-163, 2013; D. Cimba, J. Wagner, and A. Baviskar, “Investigation of active torsion bar actuator configurations to reduce vehicle body roll,” Vehicle System Dynamics, vol. 44, no. 9, pp. 719-736, 2006; D. Odenthal, T. Bunte, and J. Ackermann, “Nonlinear steering and braking control for vehicle rollover avoidance,” in 1999 European Control Conference (ECC), pp. 598-603, IEEE, 1999; E. Dahlberg, Commercial vehicle stability-focusing on rollover. PhD thesis, Institutionen för farkostteknik, 2001; T. A. Brown and D. S. Rhode, “Roll over stability control for an automotive vehicle,” Jul. 17 2001. U.S. Pat. No. 6,263,261; J. Lu, D. Messih, and A. Salib, “Roll rate based stability control-the roll stability control system,” in Proceedings of the 20th Enhanced Safety of Vehicles Conference, no. 07-0136, Citeseer, 2007; B.-C. Chen and H. Peng, “Differential-braking-based rollover prevention for sport utility vehicles with human-in-the-loop evaluations,” Vehicle system dynamics, vol. 36, no. 4-5, pp. 359-389, 2001; S. Solmaz, M. Corless, and R. Shorten, “A methodology for the design of robust rollover prevention controllers for automotive vehicles: Part 1-differential braking,” in Proceedings of the 45th IEEE Conference on Decision and Control, pp. 1739-1744, IEEE, 2006; [M. B. Alberding, J. Tjøonnãs, and T. A. Johansen, “Integration of vehicle yaw stabilisation and rollover prevention through nonlinear hierarchical control allocation,” Vehicle system dynamics, vol. 52, no. 12, pp. 1607-1621, 2014]. Traction system braking to regulate longitudinal velocity [E. Dahlberg, Commercial vehicle stability-focusing on rollover. PhD thesis, Institutionen för farkostteknik, 2001; T. A. Brown and D. S. Rhode, “Roll over stability control for an automotive vehicle,” Jul. 17 2001. U.S. Pat. No. 6,263,261; J. Lu, D. Messih, and A. Salib, “Roll rate based stability control-the roll stability control system,” in Proceedings of the 20th Enhanced Safety of Vehicles Conference, no. 07-0136, Citeseer, 2007] and differential braking [B.-C. Chen and H. Peng, “Differential-braking-based rollover prevention for sport utility vehicles with human-in-the-loop evaluations,” Vehicle system dynamics, vol. 36, no. 4-5, pp. 359-389, 2001; S. Solmaz, M. Corless, and R. Shorten, “A methodology for the design of robust rollover prevention controllers for automotive vehicles: Part 1-differential braking,” in Proceedings of the 45th IEEE Conference on Decision and Control, pp. 1739-1744, IEEE, 2006; M. B. Alberding, J. Tjønnãs, and T. A. Johansen, “Integration of vehicle yaw stabilisation and rollover prevention through nonlinear hierarchical control allocation,” Vehicle system dynamics, vol. 52, no. 12, pp. 1607-1621, 2014] have both been identified as effective actuators for reducing lateral acceleration and mitigating the risk of rollovers.

To prevent vehicle rollover, various control algorithms have been used striving to provide passengers with a smooth ride and a high degree of safety. In S. Yim, “Design of a preview controller for vehicle rollover prevention,” IEEE Transactions on Vehicular Technology, vol. 60, no. 9, pp. 4217-4226, 2011, a linear quadratic static output feedback (LQ SOF) using sliding mode control is introduced to design a preview controller for vehicle rollover prevention, which considers the lateral acceleration as a previewed disturbance. A Model Predictive Control (MPC) approach is presented in S. Lee, F. Yakub, M. Kasahara, and Y. Mori, “Rollover prevention with predictive control of differential braking and rear wheel steering,” in 2013 6th IEEE Conference on Robotics, Automation and Mechatronics (RAM), pp. 144-149, IEEE, 2013, to prevent untripped rollovers of heavy vehicles when execute in a panic lane-change maneuver in order to avoid an obstacle in the path. In B.-C. Chen and H. Peng, “Differential-braking-based rollover prevention for sport utility vehicles with human-in-the-loop evaluations,” Vehicle system dynamics, vol. 36, no. 4-5, pp. 359-389, 2001, an anti-rollover control algorithm that is based on the Time-To-Rollover (TTR) metric is presented. The proposed method utilizes the differential-braking effector as a means of mitigating the risk of rollovers.

Both the direct and indirect methods necessitate auxiliary rollover control effectors to generate the required force or moment for rollover mitigation. The implementation of such effector redesign or retrofitting of existing vehicles can be prohibitively expensive. Thus, existing methods for rollover prevention and mitigation typically employ actuators that are not available on typical vehicles.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

In view of the above drawbacks with current systems, the present inventors sought a solution by using existing control effectors, such as the steering wheel and braking system, with minimal modification to the existing ADAS vehicle design package. The proposed method can be implemented in a fully autonomous trajectory tracking control system.

And so, unlike most, if not all, existing methods for rollover control (which rely on additional actuators that are not commonly available on most vehicles), aspects of the present control method rely on the existing control actuators, such as steering, throttle and brakes. Embodiments of the present control method include an augmentation to the present inventors' patented wheeled vehicle trajectory tracking controller (see U.S. Pat. No. 11,366,478), which has the advantage of allowing the controller bandwidths to be adjusted in real time with stability guarantee to allow for adaptation to adverse operating conditions. Based on published research of the present inventors, changing the bandwidth ratio in a multi-loop system can tradeoff the tracking performance (accuracy) for increased stability margin. The main cause of rollover is an excessive lateral force typically caused by sudden turning at a high speed. The lateral force, known as the centrifugal force, is proportional to the longitudinal speed times the yaw (turning) rate. The present inventors' rollover prevention and mitigation controller can reduce the lateral force (centrifugal force) or even reverse it by slowing down the vehicle while manipulating the steering angle to reduce/reverse the yaw rate. However, slowing down the vehicle speed or turning rate would inevitably cause large tracking errors, which may cause a high-performance tracking controller to lose stability. In order to prevent this loss of stability, a bandwidth adaptation scheme is augmented to the baseline tracking controller to allow momentary relaxation of the tracking performance or even abandon the tracking objective while the excessive lateral force is being combatted to prevent or arrest an imminent rollover.

Thus, in certain aspects of the present invention, a multi-mode rollover mitigation control is proposed to prevent vehicles from rollover within a trajectory tracking scheme. One baseline control mode, one Rollover Prevention (RP) mode, one Rollover Arrest (RA) mode, and one Rollover Restoration (RR) mode. The baseline controller is developed based on three-degree-of-freedom (DOF) vehicle dynamics with constant bandwidths by singular perturbation principle. A 4DOF nonlinear vehicle dynamics model is first developed, and the rollover problem is treated as the increase of the singular perturbation due to the roll dynamics. Then the problem is tackled by the bandwidth adaptation method with 3DOF baseline controller reconfiguration in the RP mode. The time-varying bandwidth adaptive control scheme is experimentally determined and augmented to the baseline controller for real-time trade-off between the tracking performance and vehicle stability tolerance capability. For the extreme situation where the adaptation law can't retain the stability, the RM mode will be activated by abandoning the mission trajectory. The effectiveness of the proposed rollover mitigation system is demonstrated for a double lane change case in MATLAB/Simulink.

This invention can be used for passenger cars, light trucks and commercial vehicles such as semi-trucks. With suitable but nontrivial modification of the algorithm, it can be applied to tractor-trailer vehicles as well.

### BRIEF DESCRIPTION OF THE DRAWINGS

The accompanying drawings, which are incorporated in and constitute a part of this specification, illustrate embodiments of the present invention and, together with the Detailed Description given below, serve to explain the present invention.

FIG. 1 is a schematic showing vehicle rolling phases.

FIG. 2 is a 3DOF trajectory linearization controller block diagram.

FIG. 3 is a schematic showing a trajectory linearization concept.

FIG. 4 is a schematic of a rollover mitigation state machine.

FIG. 5 is a schematic of adaptive PI gain structure.

FIG. 6 is a diagram of roll and yaw error dynamics in a singular perturbation model.

FIG. 7 are graphs of a double lane change evading trajectory.

FIG. 8 is a graph showing nominal ϕ signal.

FIG. 9 is a graph showing vehicle position tracking.

FIG. 10 is a graph showing load transfer ratio.

FIG. 11 is a chart of flag.

FIG. 12 are graphs showing vehicle yaw rate and velocity tracking.

FIG. 13 are graphs showing vehicle roll tracking.

FIG. 14 are graphs showing vehicle lateral tracking.

FIG. 15 are graphs showing vehicle trajectory tracking error.

FIG. 16 are graphs showing control signals.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, in view of the above drawbacks with current systems, the present inventors sought a solution by using existing control effectors, such as the steering wheel and braking system, with minimal modification to the existing ADAS vehicle design package. The proposed method can be implemented in a fully autonomous trajectory tracking control system.

And so, unlike most, if not all, existing methods for rollover control (which rely on additional actuators that are not commonly available on most vehicles), aspects of the present control method rely on the existing control actuators, such as steering, throttle and brakes. Embodiments of the present control method include an augmentation to the present inventors' patented wheeled vehicle trajectory tracking controller (see U.S. Pat. No. 11,366,478), which has the advantage of allowing the controller bandwidths to be adjusted in real time with stability guarantee to allow for adaptation to adverse operating conditions. Based on published research of the present inventors, changing the bandwidth ratio in a multi-loop system can tradeoff the tracking performance (accuracy) for increased stability margin. The main cause of rollover is an excessive lateral force typically caused by sudden turning at a high speed. The lateral force, known as the centrifugal force, is proportional to the longitudinal speed times the yaw (turning) rate. The present inventors' rollover prevention and mitigation controller can reduce the lateral force (centrifugal force) or even reverse it by slowing down the vehicle while manipulating the steering angle to reduce/reverse the yaw rate. However, slowing down the vehicle speed or turning rate would inevitably cause large tracking errors, which may cause a high-performance tracking controller to lose stability. In order to prevent this loss of stability, a bandwidth adaptation scheme is augmented to the baseline tracking controller to allow momentary relaxation of the tracking performance or even abandon the tracking objective while the excessive lateral force is being combatted to prevent or arrest an emanant rollover.

Thus, in certain aspects of the present invention, a multi-mode rollover mitigation control is proposed to prevent vehicles from rollover within a trajectory tracking scheme. One baseline control mode, one Rollover Prevention (RP) mode, one Rollover Arrest (RA) mode, and one Rollover Restoration (RR) mode. The baseline controller is developed based on three-degree-of-freedom (DOF) vehicle dynamics with constant bandwidths by singular perturbation principle. A 4DOF nonlinear vehicle dynamics model is first developed, and the rollover problem is treated as the increase of the singular perturbation due to the roll dynamics. Then the problem is tackled by the bandwidth adaptation method with 3DOF baseline controller reconfiguration in the RP mode. The time-varying bandwidth adaptive control scheme is experimentally determined and augmented to the baseline controller for real-time trade-off between the tracking performance and vehicle stability tolerance capability. For the extreme situation where the adaptation law can't retain the stability, the RM mode will be activated by abandoning the mission trajectory. The effectiveness of the proposed rollover mitigation system is demonstrated for a double lane change case in MATLAB/Simulink.

Aspects of the present invention build on the present inventors' previous research [Y. Chen and J. J. Zhu, “Car-like ground vehicle trajectory tracking by using trajectory linearization control,” in ASME 2017 Dynamic Systems and Control Conference, pp. V002T21A014-V002T21A014, American Society of Mechanical Engineers, 2017; Y. Chen and J. J. Zhu, “Trajectory tracking and control for nonholonomic ground vehicle: Preliminary and experimental test,” in ASME 2018 Dynamic Systems and Control Conference, pp. V003T37A007-V003T37A007, American Society of Mechanical Engineers, 2018; Y. Chen, J. J. Zhu, and L. Lin, “Integrated forward and reverse trajectory tracking control for car-like ground vehicle,” in Dynamic Systems and Control Conference, vol. 59162, p. V003T21A007, American Society of Mechanical Engineers, 2019; Y. Chen and J. J. Zhu, “Singular perturbation margin assessment for Iti system with zero dynamics,” in 2022 American Control Conference (ACC), pp. 3164-3171, IEEE, 2022; J. J. Zhu, “Nonlinear tracking and decoupling by trajectory linearization,” Lecture note, NASA Marshall Space Flight Center, 1998]. It aims to further discuss the vehicle trajectory tracking by encompassing extreme driving conditions in addition to normal driving conditions. In the context of the vehicle system, the roll dynamics can be considered as a parasitic effect to the system. Generally, during normal driving conditions, if the roll angle remains within the safety region, it is not necessary to focus on roll control. However, if the roll angle exceeds its stability region and poses a risk to the overall system stability, then roll control becomes critical. To this end, beside the baseline control algorithm, additional two modes are incorporated into the system to address roll stability, a rollover prevention (RP) mode and a rollover mitigation (RM) mode.

The Rollover Prevention (RP) mode with a time-varying bandwidth adaptation is implemented in the 3DOF MNL-TLC baseline controller introduced in Y. Chen and J. J. Zhu, “Car-like ground vehicle trajectory tracking by using trajectory linearization control,” in ASME 2017 Dynamic Systems and Control Conference, pp. V002T21A014-V002T21A014, American Society of Mechanical Engineers, 2017 for real-time trade-off between the tracking performance and maximum roll dynamic tolerance capability. In order to address extreme conditions, i.e., after wheels lift-off, a Rollover Mitigation (RM) mode is designed to temporarily abandon the tracking mission and prioritize vehicle stability, preventing rollovers and ensuring safety. In the RA mode, the vehicle is modeled as an invert pendulum around the wheel-ground contact line. The lateral force induced rolling moment is produced through yaw dynamics by counter steering the wheel. A TLC-based exponentially stabilized closed-loop roll tracking control algorithm is designed to guarantee the overall system is ultimately bounded within the vehicle's intrinsic domain of attraction. The proposed method is applicable for both tripped and untripped rollovers.

Below, a 4DOF nonlinear vehicle dynamic model is established, and both RP mode and RM mode design with the switching law will be presented. MAT-LAB/Simulink simulation results are described in Section IV. And conclusions are drawn in Section V.

### I. Vehicle Nonlinear Model A

### A. Vehicle Rigid Body Dynamics

A ground vehicle is a complex multi-body mechanical system consisting of many flexibly linked masses. However, from motion control point of view, it can be separated into two parts: sprung and unsprung masses. The sprung mass includes the vehicle body, chassis, and the internal components above include the suspension system. On the other hand, the unsprung part includes all of the components under the suspension system. In general, the sprung mass is much larger than the unsprung mass. The larger the ratio of sprung mass to unsprung mass, the less the vehicle is affected by bumps, dips, and other surface imperfections. Herein, subscriptsₛ and ᵤ represent sprung and unsprung mass, respectively.

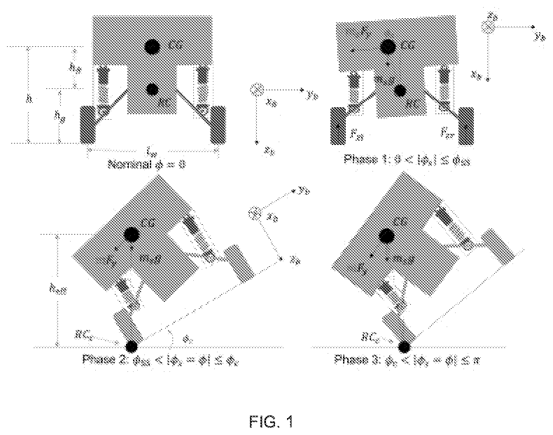

The vehicle roll dynamics can be divided into three distinct phases: (1) suspension system unsaturated |ϕₛ|≤ϕ_{SS}, in which ϕ_{SS} is the critical value for suspension system saturation; (2) suspension saturated and one side of the wheels about to lift off ground, but ϕ≤ϕ_{c}, where ϕ_{c} is the critical point when CG is on the top of the wheel that are on the ground, where the roll moment due to gravity is zero; and (3) one side of the wheels has lift-off and ϕ>ϕ_{c}. FIG. 1 depicts these phases.

During phase 1, the suspension system is fully functional, and the rotational behavior of the vehicle is primarily determined by the sprung mass. The suspension system of a vehicle can create an inherent region of attraction, and there is no need for active intervention. In phase 2 and phase 3, the sprung and unsprung masses have combined into one rigid body, and the rolling center has moved to the side of wheels in direction of the roll, as shown in FIG. 1 as RC_{c}. During phase 2, the vehicle dynamics behave like a bicycle, but the control objective is to make the vehicle fall on the ground in the opposite direction of the rollover. Thus, the roll dynamics can be modeled as an undamped inverted pendulum. However, during phase 2, the roll motion is still statically stable due to the gravity. Once the vehicle's roll angle ϕ exceeds the critical value ϕ_{c}, it enters into phase 3. During this phase, the center of gravity (CG) contributes an additional rollover moment, resulting in an increased likelihood of rollover. Moreover, the effectiveness of countering the roll motion through the use of yaw rate will be diminishing. Arresting the rollover will become increasingly difficult. Herein, the present inventors initially focus on phase 1 and phase 2, and will develop a variable bandwidth adaptive control strategy for phase 1 as Rollover Prevention (RP) control, and a TLC strategy for phase 2 as Rollover Mitigation (RM). The RM control should also be effective for the initial stage of phase 4, depending on available steering angle and steering rate that can be allocated for roll control.

In this subsection, a multi-DOF vehicle model is presented by rigid body equation of motion. The present inventors also focus on the coupling effect between roll and yaw motion and proposing potential control strategies, such as yaw steering, to mitigate the risk of rollover. The 3DOF vehicle modeling is described in Y. Chen and J. J. Zhu, “Car-like ground vehicle trajectory tracking by using trajectory linearization control,” in ASME 2017 Dynamic Systems and Control Conference, pp. V002T21A014-V002T21A014, American Society of Mechanical Engineers, 2017, Eq (1)<(4). The translational dynamics remain un-changed. However, to provide a more comprehensive under-standing of the rotational behavior, the rotational dynamics are extended from a 1DOF model to a 2DOF model. This extension is based on the assumption that the pitch dynamics are limited, and takes into account both pre and post lift off conditions. As a result, a four-degree-of-freedom (4DOF) vehicle model has been formulated.

### Translational Kinematics:

$$[ \begin{matrix}{\dot{x}}_{n} \\ {\dot{y}}_{n}\end{matrix} ] = [ \begin{matrix}cos ψ & - sin ψ \\ sin ψ & cos ψ\end{matrix} ] [ \begin{matrix}u \\ v\end{matrix} ] \qquad ( 1 )$$

### Translational Dynamics:

$$[ \begin{matrix}\dot{u} \\ \dot{v}\end{matrix} ] = [ \begin{matrix}0 & r \\ - r & 0\end{matrix} ] [ \begin{matrix}u \\ v\end{matrix} ] + \frac{1}{m} [ \begin{matrix}{F}_{x} \\ {F}_{y}\end{matrix} ] \qquad ( 2 )$$

### Rotational Kinematics:

$$[ \begin{matrix}{ϕ}_{x} \\ {ψ}_{s}\end{matrix} ] = [ \begin{matrix}{p}_{x} \\ r cos {ϕ}_{s}\end{matrix} ] \qquad ( 3 )$$

Rotational Dynamics before lift-off:

$$[ \begin{matrix}{\dot{p}}_{x} \\ {\dot{r}}_{s}\end{matrix} ] = [ \begin{matrix}\frac{1}{\text{?}} & 0 \\ 0 & \frac{1}{\text{?}}\end{matrix} ] [ \begin{matrix}{L}_{m} \\ {N}_{m}\end{matrix} ] \qquad ( 4 )$$

$$\text{?} \text{indicates text missing or illegible when filed}$$

Rotational Dynamics after lift-off:

$$[ \begin{matrix}\dot{p} \\ \dot{r}\end{matrix} ] = [ \begin{matrix}\frac{1}{\text{?}} & 0 \\ 0 & \frac{1}{\text{?}}\end{matrix} ] [ \begin{matrix}{L}_{m} \\ {N}_{m}\end{matrix} ] \qquad ( 5 )$$

$$\text{?} \text{indicates text missing or illegible when filed}$$

### II. Baseline Trajectory Tracking Controller

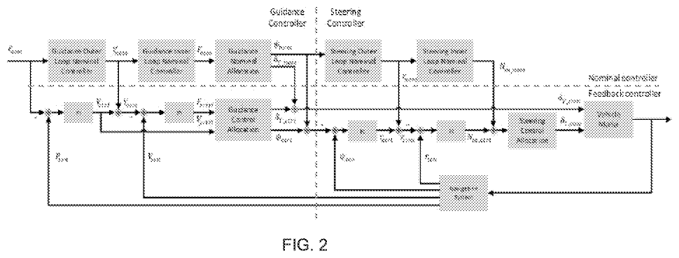

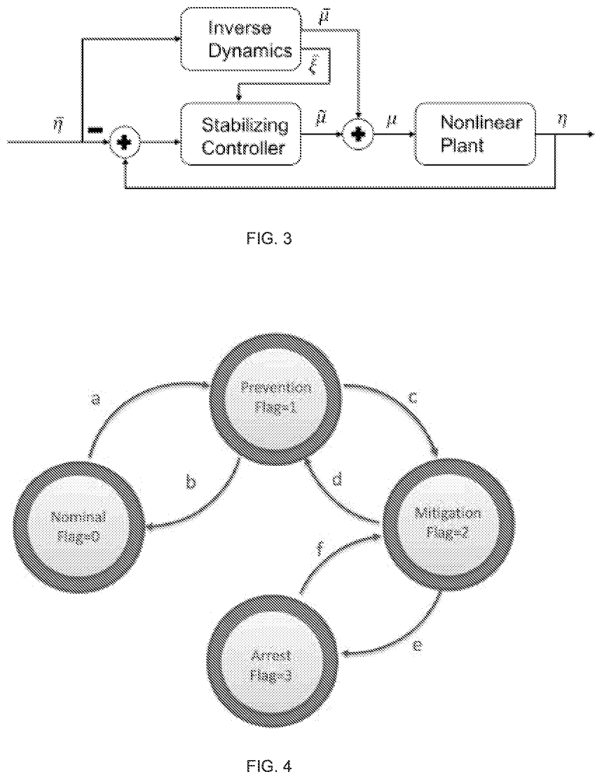

The ground vehicle dynamics naturally exhibit timescale separations, i.e. steering dynamics are faster than translational dynamics, and vehicle dynamics are faster than kinematics. Taking advantage of the natural timescale separation in the 3-DOF rigid-body dynamics, the baseline controller is designed as a multiple-timescale nested-loop (MNL) control architecture [Y. Chen and J. J. Zhu, “Singular perturbation margin assessment for Iti system with zero dynamics,” in 2022 American Control Conference (ACC), pp. 3164-3171, IEEE, 2022]. In each loop, the Trajectory Linearization Control (TLC) technique is employed as shown in FIG. 3 due to its high computational efficiency and effectiveness for the high-order nonlinear and time-varying tracking error dynamics in non-holonomic ground vehicle trajectory tracking. The overall closed-loop system consists of 4 loops as shown in FIG. 2, which are the guidance outer and inner loop, and the steering outer and inner loop.

The nominal controller for each loop is an open-loop pseudo-dynamic-inverse of the corresponding 3DOF rigid-body equation and the force models of motions, as shown in the previous section. The feedback tracking error stabilizing controller for each loop employs Proportional-Integral (PI) control law U_{ctrl}=−Kp [symbol] Xₑᵣᵣ−K_{I} [symbol] ∫₀ [symbol] Xₑᵣᵣ(τ)dt, where Xₑᵣᵣ and U_{ctrl} is the tracking error signal. See Y. Chen and J. J. Zhu, “Car-like ground vehicle trajectory tracking by using trajectory linearization control,” in ASME 2017 Dynamic Systems and Control Conference, pp. V002T21A014-V002T21A014, American Society of Mechanical Engineers, 2017; Y. Chen and J. J. Zhu, “Trajectory tracking and control for nonholonomic ground vehicle: Preliminary and experimental test,” in ASME 2018 Dynamic Systems and Control Conference, pp. V003T37A007-V003T37A007, American Society of Mechanical Engineers, 2018 (incorporated by reference herein) for details on the forward motion controller design.

### III. Active Rollover Protection Design

Consider a vehicle is driving at high speed and experiences an abrupt turn, the longitudinal velocity will be converted into a large centrifugal force [the ru term in the second equation of Eq (2)]. This sudden increase in force is established as a key factor in vehicle rollover. As a result, braking to reduce the longitudinal speed and lateral acceleration is recognized as a highly effective method to mitigate the risk of rollover. In certain circumstances, reducing speed through braking may not be enough to prevent rollover, particularly when tire lift-off occurs, such as tripped rollover. The objective of rollover mitigation control is to effectively address the issue of vehicle rollover in both low- and high-propensity scenarios and guide the vehicle back to its 3DOF trajectory tracking task. This approach seeks to ensure the safety and stability of the vehicle while maintaining its mission trajectory. Therefore, three additional modes are proposed to be added to the existing 3DOF MNL-TLC control algorithm. These modes include a Rollover Prevention (RP) mode, and a Rollover mitigation (RM) mode, and Rollover Arrest (RA) mode.

To evaluate the performance of the rollover prevention, the load transfer ratio (LTR) is selected as the Rollover Index (RI),

$$LTR = \frac{{F}_{zl} - {F}_{zr}}{{F}_{zl} + {F}_{zr}} \qquad ( 6 )$$

where F_{zl} and F_{zr} are the total normal tire forces of the right side and the left side of the vehicle, respectively. Intuitively, the LTR is bounded within [−1,1] . It reaches its limits, 1 or −1, once the hazardous tire lift-off happens.

### A. Finite-State Machine

The rollover mitigation system is characterized by a set of operating modes including the nominal mode, the RP mode, the RA mode, and the RR mode. The mode transition is driven by a finite state machine in FIG. 4. The functions of these modes are: (i) a baseline controller presented in Y. Chen and J. J. Zhu, “Car-like ground vehicle trajectory tracking by using trajectory linearization control,” in ASME 2017 Dynamic Systems and Control Conference, pp. V002T21A014-V002T21A014, American Society of Mechanical Engineers, 2017 for 3DOF trajectory tracking designed by MNL-TLC as the nominal mode, (ii) an RP mode with a bandwidth adaptation augmentation to the baseline controller, which aims to improve the rollover prevention capability by using the time-varying PD-eigenvalues to trade-off between tracking performance and increased stability margin and robustness in the presence of excessive lateral acceleration, (iii) an RM control function to recover and maintain safe roll condition by applying a TLC-based roll tracking control at the cost of temporarily abandoning the mission trajectory when the lateral acceleration becomes hazardous, and (iv) an RA control function to prevent vehicle roll angle keeping increase.

The switching logic variable flag is one of the outputs of the rollover mitigation control subsystem. Each of the modes corresponds to one flag state in the finite state machine and can be transferred automatically under the conditions shown in Table I. When one state is triggered, the other states are set to standby.

TABLE I
STATE MACHINE TRANSITION AND CONDITION

| Transition | Condition |
|---|---|
| a | \|LTR\| ≥ 0.6 |
| b | \|LTR\| < 0.6, \|R\| < 0.5 m |
| c | \|LTR\| ≥ 0.95 |
| d | \|LTR\| < 0.8 |
| e | \|ϕ\| ≥ ϕ_{c} |
| f | \|ϕ\| < ϕ_{c} |

### B. Rollover Prevention

As was discussed in the preceding section, the vehicle is able to accommodate roll disturbance within a static domain of attraction defined by |LTR|<1. Based on singular perturbation margin theory, vehicle rollover propensity can be managed at the cost of reduced tracking performance by reducing the bandwidth of the closed-loop tracking error dynamics. Accordingly, instead of using constant natural frequency ω_{n,nom,ij}, time-varying ω_{n,ij}(t), is applied for a real-time trade-off between tracking performance and robustness in order to prevent vehicle rollover. Herein, a TLC-based adaptive control is proposed, where the vehicle is subject to high rollover propensity due to sharp/overcorrecting turns or speeding, and the control system is augmented with a time-varying bandwidth adaptive controller.

Vehicle rollover propensity can be managed at the cost of reduced tracking performance by reducing the bandwidth of the closed-loop tracking error dynamics. Accordingly, instead of using constant natural frequency ω_{n,nom,ij}, time-varying ω_{n,ij}(t), is applied for a real-time trade-off between tracking performance and robustness in order to prevent vehicle rollover. Herein, a TLC-based adaptive control is proposed, where the vehicle is subject to high rollover propensity due to sharp/overcorrecting turns while speeding, and the control system is augmented with a time-varying bandwidth adaptive controller.

In the MNL-TLC control system, the linear time-varying closed-loop tracking error dynamics are given by

\ddot{X}ᵢⱼ+αᵢⱼ₂(t)\dot{X}ᵢⱼ+αᵢⱼ₁Xᵢⱼ=0, (7)

These dynamics can be synthesized using the constant-damping time-varying PD-eigenvalues [J. J. Zhu, “Nonlinear tracking and decoupling by trajectory linearization,” Lecture note, NASA Marshall Space Flight Center, 1998]

ρᵢⱼ(t)=(−ζᵢⱼ±j\sqrt{1−ζᵢⱼ²})ω_{n,ij}(t) (8)

By the PD-spectral synthesis formula

$${α}_{ij 1} ( t ) = {ω}_{n , ij}^{2} ( t ) , {α}_{ij 2} ( t ) = 2 {ζ}_{ij} {ω}_{n , ij} ( t ) - \frac{{\dot{ω}}_{n , ij} ( t )}{{ω}_{n , ij} ( t )} \qquad ( 9 )$$

where the index i is the loop number counting from outer loop to inner loop, and j is the channel number; ω_{n,ij}(t) are time-varying natural frequencies and ζ_{i j} are the constant damping ratios of the desired closed-loop dynamics for each error state variable xᵢⱼ.

For a multi-loop controller, by the singular perturbation time-scale separation theory, the bandwidths of the outer loops should be reduced accordingly to preserve stability when the bandwidth of an inner-loop is reduced. Thus, the adaptation gains k_{a,i}(t), as the outputs of rollover prevention mode, are multiplied to the nominal bandwidth ω_{n,nom,ij}

ω_{n,ij}(t)=k_{α,i}(t)ω_{n,nom,ij} (10)

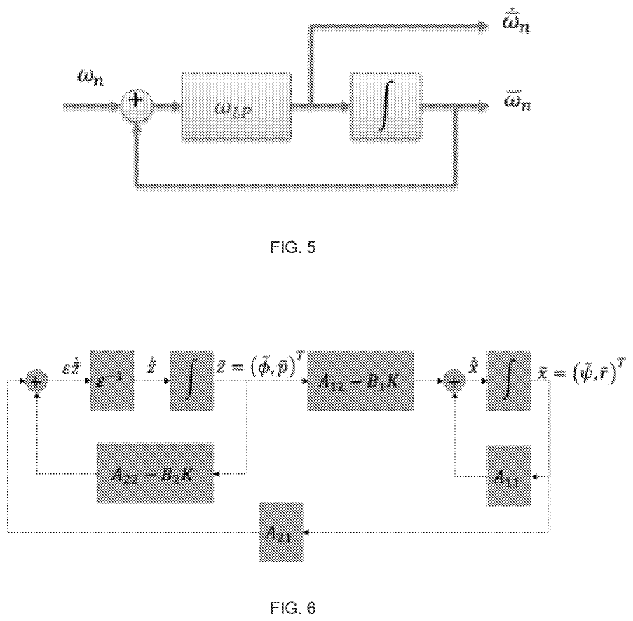

to effect simultaneous bandwidth adaptation. According to Eq (9) and Eq (10), the bandwidth adaptation can be implemented using a first-order pseudo-differentiator as shown in FIG. 5 , where ω_{LP} is a design parameter that determines time constant of the ω_{n,ij}(t) in response to a step bandwidth command. In RP mode, the adaptation gains are inversely proportional to the Rollover Index LTR. Considerably reducing the translational dynamics (velocity loop) tracking performance by kₐ₂ and slightly slowing the steering dynamics (yaw rate loop) by kₐ₄ can provide a positive response on decreasing the lateral centrifugal acceleration (ru term). As a consequence, reducing the effective bandwidth of an inner-loop amounts to an increase in singular perturbation to its outer loops. Therefore, by the singular perturbation (time-scale separation) principle, the bandwidths of the outer loops should be reduced (by Kₐ₁ and kₐ₃) accordingly to preserve stability at the cost of reduced tracking performance.

TABLE II
ROLLOVER PREVENTION ADAPTATION LAW

| | Translational | Translational | Steering | Steering |
|---|---|---|---|---|
| | Kinematics | Dynamics | Kinematics | Dynamics |
| | i = 1 | i = 2 | i = 3 | i = 4 |
| k_{a,i} | $\frac{0.001}{\vert LTR \vert}$ | $\frac{0.82}{\vert LTR \vert}$ | $\frac{0.7}{\vert LTR \vert}$ | $\frac{0.55}{\vert LTR \vert}$ |

### C. Rollover Mitigation

The Rollover Mitigation (RM) mode is designed to handle the high rollover propensity right after the wheels have started losing ground contact till the critical roll angle ϕ_{c}. Within this mode, retaining roll stability is the highest priority.

After one side of the vehicle wheels lift-off, the suspension system has hit its limitation. Thus, the vehicle can be modeled as a single rigid body with the total mass m pivoting about the contact point of the wheels that are on the ground, as shown in FIG. 1. The vehicle rotational model about CG can be simplified as

$$\begin{matrix}\begin{matrix}\dot{ψ} = r cos ϕ , & \hat{r} = \frac{{N}_{m}}{{I}_{zz}}\end{matrix} \\ \begin{matrix}\dot{ϕ} = p , & \dot{p} = \frac{{L}_{m}}{{I}_{xx}}\end{matrix}\end{matrix} \qquad ( 11 )$$

and the yaw and roll moments model is given as

$${N}_{m} = {I}_{f} ( {F}_{xtf} sin {δ}_{nom} + {C}_{β f} ( {δ}_{nom} - \frac{{v}_{nom} + {rl}_{f}}{{u}_{nom}} ) cos {δ}_{nom} ) + {l}_{r} {C}_{{β}_{r}} \frac{{v}_{nom} - {rl}_{r}}{{u}_{nom}} \qquad ( 12 )$$

$${L}_{m} = {mu}_{nom} {rh}_{eff} cos ( ϕ - {ϕ}_{c} ) + {mgh}_{eff} sin ( ϕ - {ϕ}_{c} ) + {L}_{m , ct rl}$$

where h_{eff} is effective rolling moment arm about RC_{c}, and ϕ_{c} is the critical roll angle that is the unstable equilibrium point of the rolling motion when it is viewed as an inverted pendulum about RC_{c}. Due to the symmetry of the rolling motion about the x_{b}−z_{b} plant, without loss of generality, in what follows we will assume that the rollover is in the direction of ϕ>0. When ϕ<ϕ_{c}, the CG is on the right side of the vertical line where the term mgh_{eff} sin ϕ works as a stabilizing moment to the motion, otherwise it is stabilizing.

In typical ground vehicles, the absence of a direct actuator that can generate a pure roll torque is the main challenge for preventing rollovers. To address this issue, the present inventors utilize the centrifugal force F_{y}=mur as a roll control input. Let \tilde{r}_{ϕ} be the yaw rate component that is used to stabilize roll. Then the rollover control moment L_{m,ctrl} in Eq (12)

L_{m,ctrl}=muₙₒₘh_{eff} cos(ϕₙₒₘ−ϕ_{c})\tilde{r}_{ϕ} (13)

Upon activation of the RM mode, a 2nd-order low pass filter with the nature bandwidth ω_{n,ϕ=}6 which is considered as the nature bandwidth for roll channel, is employed to generate nominal ϕₙₒₘ and ϕ′ₙₒₘ for ϕ and ϕ′ to track, with a steady state value of zero ϕ_{nom,ss}=ϕ′_{nom,ss}=0. The initial values ϕₙₒₘ(t_{RM}) and ϕ′ₙₒₘ(t_{RM}) are set to values of ϕₙₒₘ(t_{RM}) and ϕ′ₙₒₘ(t_{RM}) at the time t_{RM}, the RM mode is activated. Then the nominal roll torque is given as

L_{m,nom}=muₙₒₘrₙₒₘh_{eff} cos(ϕₙₒₘ−ϕ_{c})+mgh_{eff} sin(ϕₙₒₘ−ϕ_{c}) (14)

The tracking error dynamics are given as

$$\dot{\tilde{ψ}} = ( {r}_{nom} + \tilde{r} ) cos ( {ϕ}_{nom} + \tilde{ϕ} ) - {r}_{nom} cos {ϕ}_{nom} \qquad ( 15 )$$

$$\dot{\tilde{r}} = - \frac{{C}_{bf} {l}_{f}^{2} cos {δ}_{nom} + {C}_{br} {l}_{r}^{2}}{{I}_{zz} {u}_{nom}} ( \tilde{r} + {\tilde{r}}_{d} )$$

$$\dot{\tilde{ϕ}} = \tilde{p}$$

$$\dot{\tilde{p}} = \frac{{mu}_{nom} {h}_{eff} ( {r}_{nom} + \tilde{r} + {\tilde{r}}_{d} ) cos ( {ϕ}_{nom} + \tilde{ϕ} - {ϕ}_{C} )}{{I}_{xx}} - \frac{{mgh}_{eff} sin ( {ϕ}_{nom} + \tilde{ϕ} - {ϕ}_{C} )}{{I}_{xx}} - \frac{( {mu}_{nom} {h}_{eff} {r}_{nom} cos ( {ϕ}_{nom} - {ϕ}_{C} ) + {mgh}_{eff} sin ( {ϕ}_{nom} - {ϕ}_{C} ) )}{{I}_{xx}}$$

Linearizing the above tracking error dynamics along the nominal trajectory yields

$$A = [ \begin{matrix}0 & cos {ϕ}_{nom} & - {r}_{nom} sin {ϕ}_{nom} & 0 \\ 0 & - \frac{{C}_{bf} {l}_{f}^{2} cos {δ}_{nom} + {C}_{br} {l}_{r}^{2}}{{I}_{zz} {u}_{nom}} & 0 & 0 \\ 0 & 0 & 0 & 1 \\ 0 & {a}_{42} & {a}_{43} & 0\end{matrix} ] \qquad ( 16 )$$

$$B = {[ \begin{matrix}0 & - \frac{{C}_{bf} {l}_{f}^{2} cos {δ}_{nom} + {C}_{br} {l}_{r}^{2}}{{I}_{zz} {u}_{nom}} & 0 & \frac{{mu}_{nom} {h}_{eff} cos ( {ϕ}_{nom} - {ϕ}_{C} )}{{I}_{xx}}\end{matrix} ]}^{T}$$

$$where$$

$${a}_{42} = \frac{{mu}_{nom} {h}_{eff} cos ( {ϕ}_{nom} - {ϕ}_{C} )}{{I}_{xx} / ε} \qquad ( 17 )$$

$${a}_{43} = - \frac{( {mgh}_{eff} cos ( {ϕ}_{nom} - {ϕ}_{C} ) + {mu}_{nom} {h}_{eff} {r}_{nom} sin ( {ϕ}_{nom} - {ϕ}_{C} )}{{I}_{xx} / ε}$$

For vehicles whose length is significantly longer than their width, I_{zz} is typically an order of magnitude larger than Iₓₓ. Therefore, it is reasonable to treat roll dynamics as a singular perturbation of the yaw dynamics. Define x=[ψr]^{T} and z=[ϕp]^{T}, and let ε=Iₓₓ/I_{zz}. Then the linearized tracking error dynamics can be rewritten as a singularly perturbed system

$$[ \begin{matrix}\dot{x} \\ ε \dot{𝓏}\end{matrix} ] = [ \begin{matrix}{A}_{11} & {A}_{12} \\ {A}_{21} & {A}_{22}\end{matrix} ] [ \begin{matrix}x \\ 𝓏\end{matrix} ] + [ \begin{matrix}{B}_{1} \\ {B}_{2}\end{matrix} ] {\tilde{r}}_{ϕ} \qquad ( 18 )$$

$$where$$

$${A}_{11} = [ \begin{matrix}0 & cos {ϕ}_{nom} \\ 0 & - \frac{{C}_{bf} {l}_{f}^{2} cos {δ}_{nom} + {C}_{br} {l}_{r}^{2}}{{I}_{zz} {u}_{nom}}\end{matrix} ] , \qquad {A}_{12} = [ \begin{matrix}- {r}_{nom} sin {ϕ}_{nom} & 0 \\ 0 & 0\end{matrix} ]$$

$$\begin{matrix}{A}_{21} = [ \begin{matrix}0 & 0 \\ 0 & {a}_{42}\end{matrix} ] , & {A}_{22} = [ \begin{matrix}0 & 1 \\ {a}_{43} & 0\end{matrix}\end{matrix} ]$$

$${B}_{1} = {[ \begin{matrix}0 & - \frac{{C}_{bf} {l}_{f}^{2} cos {δ}_{nom} + {C}_{br} {l}_{r}^{2}}{{I}_{zz} {u}_{nom}}\end{matrix} ]}^{T} ,$$

$${B}_{2} = [ \begin{matrix}0 & {\frac{{mu}_{nom} {h}_{eff} cos ( {ϕ}_{nom} - {ϕ}_{C} )}{{I}_{xx} / ε} ]}^{T} = [ \begin{matrix}0 & {{B}_{2 , 2} ]}^{T}\end{matrix}\end{matrix}$$

Therefore, the above four-state system can be modeled as a two-loop system, with each loop comprising of two states. The diagram representing this is illustrated in FIG. 6. In this framework, the roll dynamics can be viewed as a fast parasitic dynamic mode that is neglected in the baseline controller design because it is small-signal exponentially stable owing to the suspension systems. However, when this mode is excited by either a tripped or untripped rolling moment, it may enter unstable operating regions where active anti-rolling control becomes necessary.

It is noted that when ϕ_{RP}<ϕ<ϕ_{c}, A_{22,21}=α₄₃<0, and A_{22,22}=0. Thus, the rolling motion is statically stable without any damping. Thus, the RM control law only needs to provide sufficient damping to dynamically stabilize the roll motion. Design a closed-loop roll rate (derivative) feedback control law

$${\tilde{r}}_{ϕ} = - \frac{{K}_{D}}{{B}_{2 , 2}} \tilde{p} \qquad ( 19 )$$

then for the roll channel (fast mode), the closed-loop augmented system can be written as

$$[ \begin{matrix}\dot{\tilde{ϕ}} \\ \dot{\tilde{p}}\end{matrix} ] = [ \begin{matrix}0 & 1 \\ {a}_{43} & - {K}_{D}\end{matrix} ] [ \begin{matrix}\tilde{ϕ} \\ \tilde{p}\end{matrix} ] \qquad ( 20 )$$

Since in general, α₄₃(t) is time-varying, let α̅=max|α₄₃(t)|=mgh_{eff} cos(ϕ_{c}). Then design

K_{D}>\sqrt{α̅} (21)

will provide exponential stability of the roll motion, as will be proved below.

The control allocation allocates the control signal L_{m,com}=L_{m,com}+L_{m,ctrl} to the steering angle to make the roll motion back to its intrinsic stability domain. A linear mapping is employed

$${δ}_{ϕ} = \frac{{L}_{m , com}}{{E}_{ϕ}} \qquad ( 22 )$$

where Eϕ =∂Lₘ/∂δ is the vehicle steer-angle control derivative. Then the total steering angle command to the vehicle is

δ_{com}=δ_{baseline}+δ_{ϕ} (23)

### IV. Simulation Results

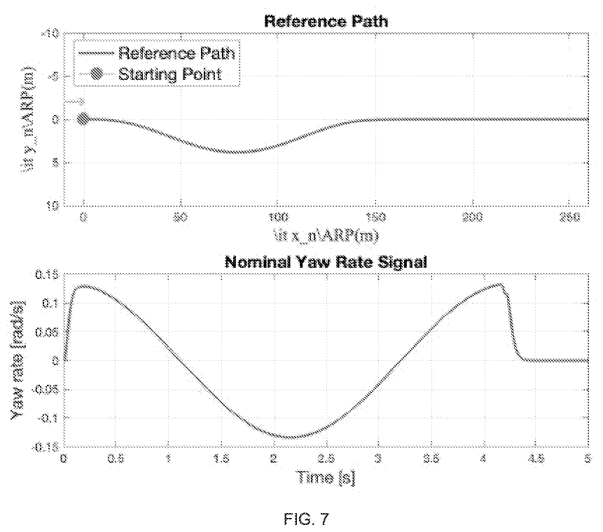

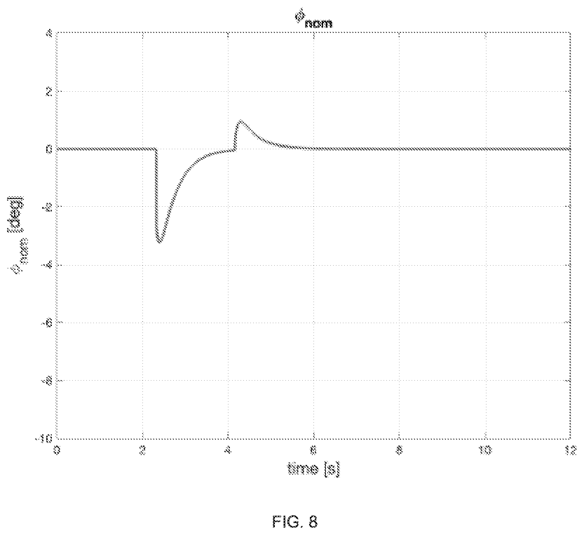

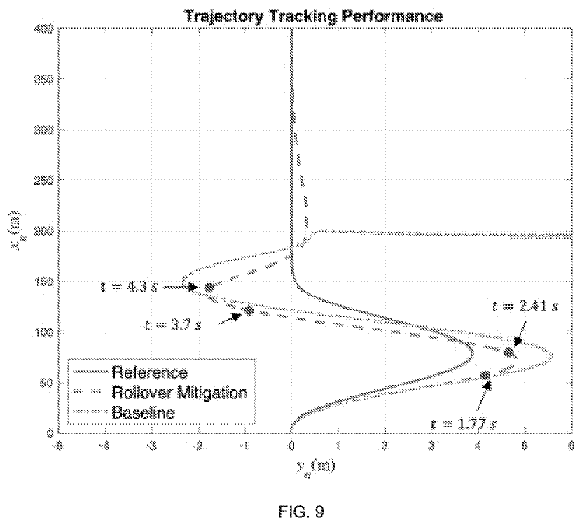

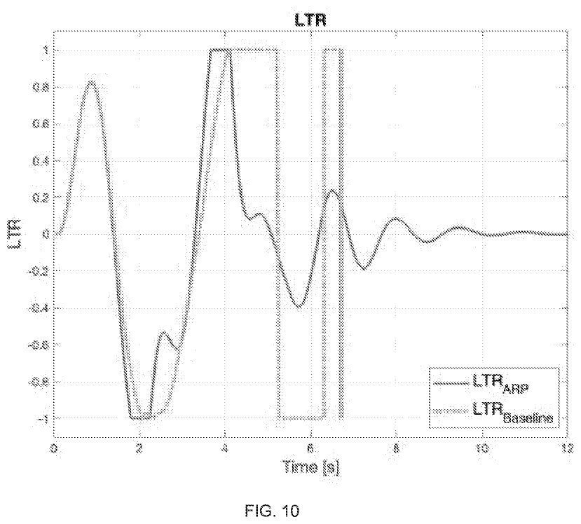

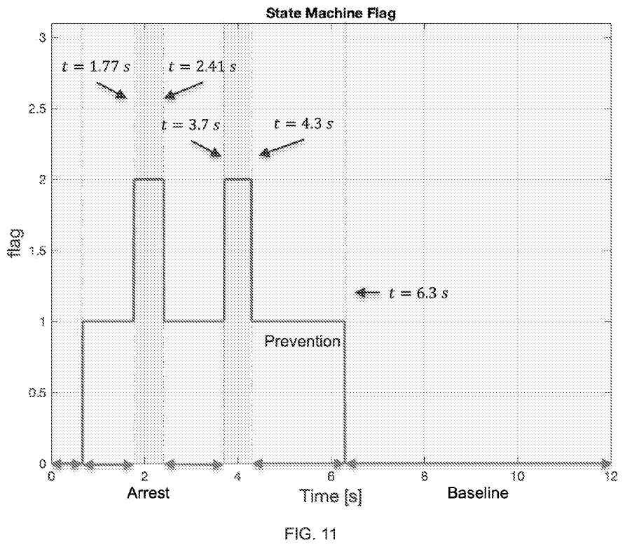

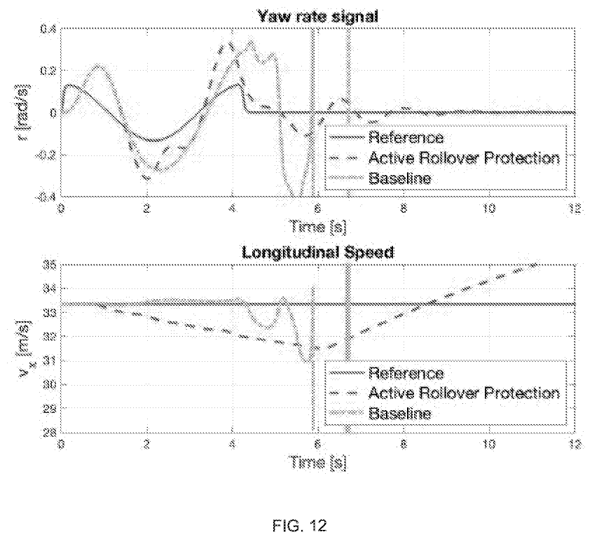

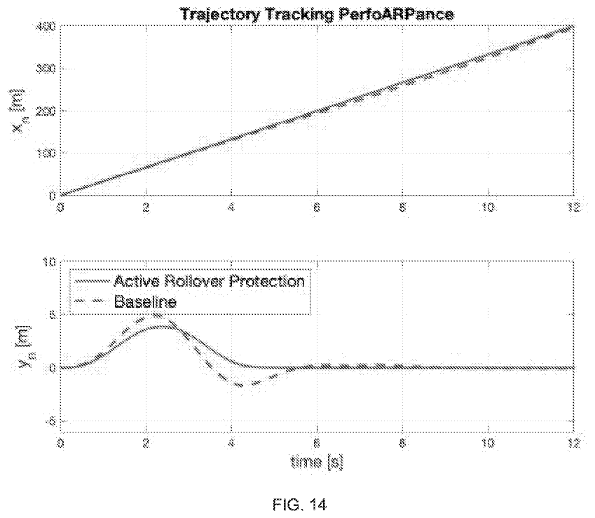

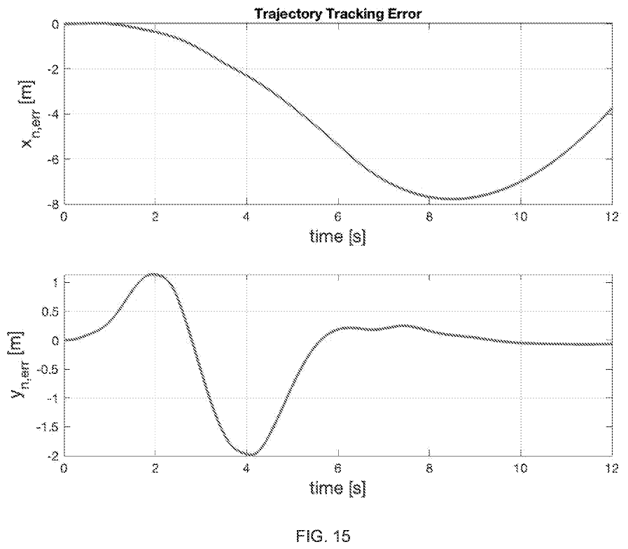

A double lane-change maneuver is studied here. The vehicle is moved to the left lane and then back to the original lane. The vehicle entering the maneuver at a speed of 120 km/h (75 mph), which is 33.3 m/s. The nominal trajectories yₙₒₘ(t) and rₙₒₘ(t) are given in FIG. 7. The nominal roll angle ϕₙₒₘ is given in FIG. 8 with the nature frequency ω_{n,ϕ}=6. The simulation results are shown in FIG. 10-16. For comparison, both the rollover mitigation controller and 3DOF MNL-TLC with constant bandwidth baseline controller results are presented. FIG. 10 shows the rollover index LTR of both baseline and active rollover protection controller. For the baseline controller in FIG. 10, the rollover occurs at t=4 s, due to the increasing yaw rate shown in FIG. 12. The active rollover protection controller prevents vehicle rollover by switching between different modes. The flag variable for each mode is shown in FIG. 11, which represents the state switching. Both baseline and active rollover protection controllers are entering with the nominal state. Then active rollover protection control algorithm switches to RP mode at t=0.68 s and subsequently with RM mode at each sharp turn. Once the vehicle has fully stabilized it returns to the baseline mode.

The yaw rate and longitudinal speed of the vehicle are shown in FIG. 12. Compared with the baseline controller, the average yaw rate magnitude is lower and stable. The baseline controller cannot guarantee the yaw stability when hazardous rollover occurs. The active rollover protection controller is designed in such a way that the stabilization of the yaw rate can be retained. During the RP and RM mode, the longitudinal speed tracking performance of the active rollover protection controller has been sacrificed, therefore, the velocity tracking performance exhibits with large tracking errors when t<6 s, as shown in FIG. 12.

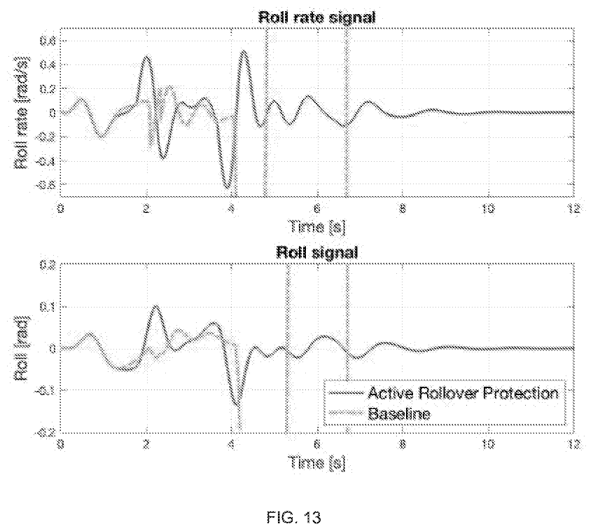

FIG. 13 shows the roll dynamics of the vehicle. Compared with the baseline controller, the vehicle controlled by rollover mitigation has a smooth roll dynamic response, and the impending rollover is successfully prevented. The trajectory tracking performance is shown in FIG. 9. Typically, the minimum width for a two-lane rural highway is at leat 12 feet (3.65 m). The maximum deviation to the right side is 1 meters, which is less than ⅓ the lane width. On the left side, the Y direction maximum deviation is 1.8 meters, which is around ½ of the lane width.

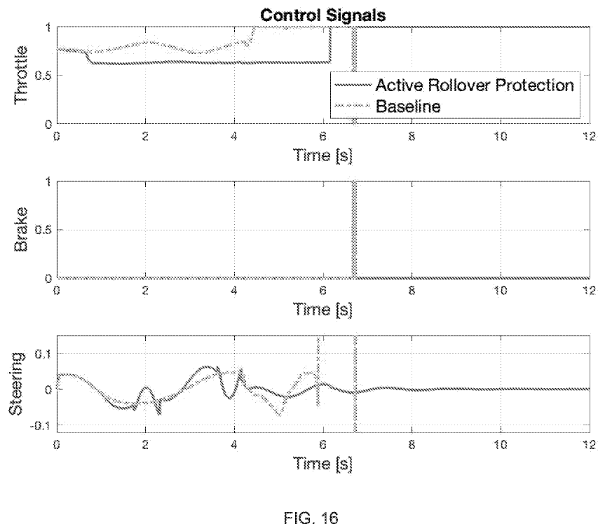

The actuator signals are shown in FIG. 16. In the rollover protection process, the state switches 6 times, and the actuator signals change at each transition. When the state transits from nominal to RP mode (t=0.68 s), the throttle has decreased significantly since translational tracking is sacrificed by the bandwidth adaptation. This reduction in throttle leads to a corresponding decrease in the vehicle's velocity. The RM mode started at t=1.77 s, which happened after the first sharp turn, as shown in FIG. 9. The vehicle is rolling towards the passenger side, in which a negative increment is observed in the value of ϕ in FIG. 13. A positive steering signal generated by TLC-based RM mode control law is added to the steering-control input, as shown in FIG. 16. After the controller switches back to the nominal mode at t=6.3 s, 100% throttle is given, and the controller is trying its best effort to catch up with the original trajectory while maintain stability.

### V. Conclusion

Herein, a multi-mode rollover mitigation control is proposed to prevent vehicles from rollover within a trajectory tracking scheme. One baseline control mode, one Rollover Prevention (RP) mode, and one Rollover Mitigation (RM) mode. The baseline controller is developed based on 3DOF vehicle dynamics with constant bandwidths by singular perturbation principle. A 4DOF nonlinear vehicle dynamics model is first developed, and the rollover problem is treated as the increase of the singular perturbation due to the roll dynamics. Then the problem is tackled by the bandwidth adaptation method with 3DOF baseline controller reconfiguration in the RP mode. The time-varying bandwidth adaptive control scheme is experimentally determined and augmented to the baseline controller for real-time trade-off between the tracking performance and vehicle stability tolerance capability. For extreme situation that the adaptation law can't retain the stability, the RM mode will be activated by sacrificing the mission trajectory. After ϕ>ϕ_{c}, RA mode is activated to provide more stiffness control. The effectiveness of the proposed rollover mitigation system is demonstrated for a double lane change case in MATLAB/Simulink.

While all of the invention has been illustrated by a description of various embodiments and while these embodiments have been described in considerable detail, it is not the intention of the Applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the Applicants' general inventive concept.

What is claimed is:

1. A rollover prevention and mitigation controller for a vehicle comprising:
a controller adapted to reduce or reverse lateral force via
a. reduction of the velocity of a vehicle; and
b. manipulation of a steering angle, wherein manipulation of the steering angle reduces or reverses the yaw rate.
